(19) United States
(12) Patent Application Publication
(10) Pub. No.: US 2002/0186698 A1
(43) Pub. Date: Dec. 12, 2002

(54) System to map remote lan hosts to local IP addresses

(76) Inventor: Glen Ceniza, Alpharetta, GA (US)

Correspondence Address: MICHAEL C. CESARANO, SUNTRUST INTERNATIONAL CENTER, 28TH FLOOR, 1 S.E. 3RD AVENUE, MIAMI, FL, 33131-1714, US

(21) Appl. No.: 09/879,639

(22) Filed: Jun. 12, 2001

(51) Int. Cl. H04L 12/28; H04L 12/56

(52) U.S. Cl. 370/401; 370/351

(57) ABSTRACT

On a plurality of IP networks where each network is remote from every other network and is connected to the internet by a VPN-router, a method of sending IP packets from a host on a home network to hosts on remote networks by assigning a network ID to each network, assigning IP addresses to hosts on each network, assigning virtual IP addresses to the home network where each virtual IP address represents a host on one of the remote networks and each virtual IP address has the same network ID as the home network, assigning virtual IP addresses to each remote network where the virtual IP addresses represent a host on the home network and each virtual IP address has the same network ID as the remote network to which it is assigned; creating, in each VPN-router, tables that cross reference each virtual IP address assigned to the VPN-router's network to the I network ID of the remote network of the host which the virtual IP address represents, and cross referencing the IP address of each host on the VPN-router's network to the virtual IP addresses representing those hosts on other networks; and sending a plurality of IP packets from one or more hosts on the home network to one or more hosts on remote networks by addressing the packets to virtual IP addresses assigned to the home network representing the destination hosts on the remote networks.

This invention relates to a system for mapping remote hosts located on remote local area networks connected to the internet to appear as if they are devices attached to a single local area network (LAN).

### BACKGROUND OF THE INVENTION

The protocol used for internet communications is TCP/IP. TCP/IP is actually a suite of protocols that work in conjunction with one another to provide complete communications services between and across networks. When a data packet is to be delivered from a host device on a local network to a host on a remote network, the packet must be “addressed” to the logical address of the destination device, and must then be routed from the local network to that destination device through a series of jumps, or “hops” across network segments connected by routers until it reaches the destination network, where it is sent to the destination device. “IP addressing” is used to identify the destination network and receiving host on that network.

Since its inception, TCP/IP (IPv4) has used a 32-bit addressing scheme (the “IP address”) to uniquely identify devices attached to the internet. These addresses, consisting of 32 bits grouped into 4 octets, are easily recognized in their familiar xxx.xxx.xxx.xxx decimal format, which is well-known to users of the internet.

Each IP address includes a network identification (netID) and a host identification (hostID). The netID may comprise between the first 8 bits to 24 bits of the IP address, with the remainder indicating the hostID, depending upon whether the network is a class A, B, or C network. In class A networks, the first octet is the net ID, and the last three are the hostID. For class B networks, the netID is the first two octets, and the hostID is the last two octets. Class C networks have a netID of the first three octets, with the last octet being the hostID. An IP network consists of a group of hosts that share the same netID. Through this addressing scheme, groups of contiguous IP addresses may be segregated into IP networks as LANs, and may be connected to each other or to the internet by routers.

Routers operate at the network and datalink layers of the OSI (“open systems interconnection”) model, and are used to route IP packets (also called “datagrams”) between IP networks, and to deliver or receive them to and from a host on the same network segment. Communications within a single IP network segment take place at the data link layer, and use physical addresses, also hardware addresses, to deliver the packet to the correct host on the segment.

IP Packets formatted for transmission across a network are carried across the network within a “frame” whose header has fields for the source and destination physical addresses of the sending and receiving hosts. Each type of network (ethernet, token ring, frame relay, etc.) has its own frame type. On ethernet networks, physical addresses may also referred to as “media access control,” or “MAC” addresses. Each network communicating device, such as a network interface card, or “NIC,” has a physical address encoded within it by the manufacturer, uniquely identifying the manufacturer and the device. Thus, when an IP packet is encased within a frame, the frame is used only to transport the packet between hardware addresses on a single network. When the IP packet is to be sent from one network to another, the frame is received at a router connecting the two networks, is broken down to determine the ultimate IP address. The IP packet is then encased within another frame for delivery across the second network to the next device, which may be another router or an ultimate destination.

When an IP packet is formatted for delivery, the sending host will first check the IP address to see whether the destination host is located on the same network. If it is not, the sending host will send the packet to a default router by placing the router's hardware address in the header of the frame and placing the packet on the local network. The router will receive the packet and, using one of a number of various routing protocols, determine the next router along the path that the packet will be delivered to. This process is repeated as a series of hops until the packet arrives at a router connected to the destination network.

If the sending host determines that the packet is destined for a host on the same network, the sending host will send the packet directly to the physical address of the receiving host using address esolution protocol, or “ARP,” to determine the correct physical address. It does this by first consulting its cache of recently resolved physical addresses to see whether the hostID part of the IP address is cross referenced to a physical address. If the physical address is found within the cache, it is then written to the destination field of the frame header and sent to the network. If the physical address is not found within the cache, the sending host will broadcast an ARP request to all devices on the network to determine the physical address of the device to which the IP packet is addressed. Upon receiving an ARP request, the device having that IP address will reply by sending its hardware address to the requesting host. All other devices will ignore the ARP request. Upon receiving the reply from the destination host, the sending host will place the physical address in the destination field of the frame header and send the packet to the network.

Because of these routing and address properties and limitations, the following guidelines should be followed when setting up or attaching to a network: All hosts having the same netID should be attached to the same network segment so that they can communicate directly. Hosts separated by a router will be unable to communicate even though they have the same netID. Hosts with different netIDs must communicate through a router, even though they may be attached to the same network segment. As used in this description, an “IP network” shall refer to a contiguous network in which all actual and virtual devices have the same netID and are not required to communicate through a router.

Internet communications take place through the sending and receipt of internet protocol (IP) “packets” across the communications medium. Each IP packet must have an IP header, which is a block of information providing, among other things, a destination IP address for the packet and the source IP address of the sending device. By analyzing this information, internet routers are able to deliver packets to the networks indicated by the IP address.

Every device connected directly to the internet must be assigned a globally unique IP address in order that communications between the device and others on the internet may take place. However, with the explosive growth of the internet in the 1990's, the number of available addresses for new devices became critically low. One solution to the problem of limited global addresses was to cease assigning a global IP address to every device on a LAN connected to the internet. Rather, through the development of network address translation technology, a LAN can be isolated from the internet by a network address translator (NAT) that is attached both to the LAN and to the internet. Using a NAT, hosts on the LAN can be assigned private IP addresses that are unique within the LAN, even though they are not globally unique. Such addresses may also be used by any other LAN, whether or not it is connected to the internet. However, any LAN using private IP addresses must also have a NAT if it is attached to the internet.

In operation, the NAT is assigned a global IP address that enables it to be seen from the internet, and is also assigned a local IP address that can be seen by other devices on the LAN. It is common for a NAT to be assigned more than one global IP address, in which case the NAT will have a pool of IP addresses from which to select one that is available. When a local host wishes to communicate across the internet, it sends an IP packet having in its destination field the global IP address of the intended recipient, and placing its own local IP address in the source field. As the packet passes through the NAT connecting the LAN to the internet, the NAT substitutes (“translates”) its own global IP address in the source field of the IP packet. Following the address translation, the NAT will forward the packet to the internet for routing and delivery. At the same time, the NAT saves information in its internal tables sufficient to enable it to identify a response from the intended recipient. When a response having as a destination address the source address substituted by the NAT is received at the NAT, the NAT will analyze the packet to ensure that it represents a valid reply, and if it is valid will “translate” the packet's destination address to the local host's IP address and forward the packet to the LAN. A more complete description of the operation of a NAT maybe found in U.S. Pat. No. 5,793,763 to Mayes et al., (“Security System for Network Address Translation Systems”).

In the internet IP addressing scheme, three blocks of contiguous IP addresses have been withdrawn from “public” use as global IP addresses, and are reserved for “private” use on LANs isolated from the internet. The reserved private address ranges are:

10.0.0.0 to 10.255.255.255 (The network 10.xxx.xxx.xxx is a single class A network supporting up to 16,777,214 host addresses);

172.16.0.0 to 172.31.255.255 (The networks 172.16.xxx.xxx to 172.31.xxx.xxx are 16 class B networks, each supporting up to 65,534 host addresses); and

192.168.0.0 to 192.168.255.255 (The networks 192.168.0.xxx to 192.168.255.xxx are 256 class C networks, each supporting up to 254 host addresses).

Using these address spaces, any isolated LAN can utilize a contiguous block of private addresses that is large enough to fit its needs. These private address spaces provide more than enough addresses to accommodate even the largest enterprise LANs.

NAT not only makes it possible for computers on an isolated LAN using private IP addresses to communicate with other computers on the internet, but it is also a security measure for isolating devices on the LAN from the internet and for keeping unwanted transmissions from reaching devices on the LAN. Most NATs are programmed to reject “unexpected” packets sent to their LANs. Such packets could include, for example, transmissions attempting to initiate a TCP session from outside the LAN, UDP packets that are not in reply to a domain name service (DNS) request initiated by a local host, certain internet control message protocol (ICMP) packets, and network file system (NFS) packets, which are designed to access an external computer's file system as if it were local.

Even though NATs are intended to protect their LANs from potentially harmful external attacks, there are a number of “good” reasons why a LAN administrator might wish to allow certain externally initiated transmissions into the LAN. At least one of these reasons is to permit monitoring and maintenance of devices on a remote LAN by a computer consultant or network administrator. Other circumstances in which it may be desirable to allow externally initiated sessions to pass through to the LAN may include external auditing of a business or records by an authorized accounting firm and inventory control of remote business sites from a single administrative location. However, the very services that such uses would require to monitor computer and records maintained on a remote LAN are precisely those uses that NATs are designed to reject. One method for overcoming this obstacle is to use a tunneling protocol between the remote LAN and the local NAT. Where the initiating and receiving devices are on separate LANs, tunneling protocols can be established between two trusted NATs to allow transmissions from a host on one LAN to be received by a host on a second, using the internet as the transmission medium. This type of communication may also incorporate encryption and authentication security measures to protect the integrity of the transmissions.

Tunneling is a process in which a packet being transmitted between remote hosts may be encapsulated as a payload within another packet for transmission between two trusted gateways or other endpoints of the tunnel. An original packet is sent from the originating host to the trusted device, where it is enclosed as the payload of a new IP packet, and a new IP header is prepended to it with its destination field containing the IP address of the device at the end of the tunnel. Upon arrival at the end of the tunnel, the new “outer” header is stripped away, and the original packet may then be forwarded to a LAN or further processed, as appropriate. By using a tunnel, it is possible to circumvent conventional routing mechanisms for the encapsulated packet during transit, while it is in the tunnel.

These prior art devices and methods are useful in making resources located on the internet and on remote LANs available to other devices. However, while the methods for accessing remote hosts are available, they tend to be awkward and time consuming to use because of the requirement for recording, saving, and re-entering the IP addresses of such hosts whenever access is desired. Where many hosts located on separate and independent LANs are to be accessed from a single “home” location, it is necessary for each remote device to be separately accessed across the internet. This is not only inefficient, but promotes the likelihood of error whenever a remote IP address must be manually entered. In addition, when two or more remote LANs are using identical IP addressing schemes, a problem arises when trying to route IP packets to those LANs since they are not uniquely addressable. What is needed is a network design in which local IP addresses on remote LANs may be translated into addresses that are unique, and thus routable, as seen from a “home” LAN. With such a design, remote hosts on isolated LANs can be seen and accessed from a “home” computer as if each remote host were situated upon the “home” computer's LAN, and the “home” LAN has a structured design such that remote LANs appear to be logical, contiguous subnets that are part of a single, manageable network.

### SUMMARY OF THE INVENTION

The present invention uses routers configured to operate as virtual-private-network routers, or VPN-routers, to connect computers on a “home” LAN to hosts on any number of separate and isolated LANs such that each remote host appears to be a local computer connected to the “home” LAN. VPN-routers combine the functions of network address translation, encryption and authentication, routing, tunneling, and address resolution protocol to determine physical addresses. In addition, VPN-routers must be able to perform normal routing and network address translation for communications with other devices on the internet that are not part of the internetwork addressing scheme of this invention.

In this invention, IP tunneling is used in conjunction with network address translation to create a tunnel from the “home” LAN's VPN-router to the VPN-router for each isolated LAN having hosts that will be accessed. Each remote LAN uses local IP addresses taken from the blocks of reserved private IP addresses, although this is not strictly a requirement of the invention. The “home” VPN-router and the remote VPN-router maybe preconfigured to incorporate encryption and authentication security. Because they are preconfigured, it will not be necessary for them to negotiate security keys in the clear each time a new session is opened.

The present invention utilizes the internal tables of the VPN-routers for the “home” LAN and each remote LAN that is appear as a local network to perform the required address translation to ensure proper delivery and receipt of “home”-LAN-to-remote-LAN communications. Because the translation tables for actual and virtual IP addresses used in the addressing scheme of this invention are preconfigured, each attached device included in the scheme must be assigned a static IP address, rather than having an address automatically assigned using dynamic host control protocol (DHCP). Devices attached to a LAN that are not part of the design of this invention may use DHCP without adversely impacting upon hosts that are included in the design of this invention. In one embodiment, each remote VPN-router will constitute one end of a single tunnel, the other end of which will be the “home” VPN-router. The “home” VPN-router will comprise one end of as many tunnels as there are remote LANs. Other embodiments may use the system of this invention to provide multiple connections between remote LANs, although the complexity of such a system will increase as the number of tunnels connecting remote LANs increases.

Each LAN is provided with an addressing scheme in which each local and remote host that will appear on the LAN is given a locally unique private IP address. Addresses assigned to hosts actually connected to a LAN will be referred to as “actual” addresses, while addresses assigned to remote hosts will be referred to as “virtual” addresses. In one embodiment, the system administrator may assign actual and virtual IP addresses from a block of contiguous private IP addresses that is large enough for each host to have a unique address. In other embodiments, particularly those in which legacy network addresses have been established and will be used without further modification, virtual addresses must be taken from the unused address space within those local addressing schemes.

Once the address schemes for all LANs within the system have been determined, each VPN-router must have its internal tables preconfigured to hold all IP addresses to be used on its LAN in the addressing design of this invention. It is possible that some actual hosts on a remote LAN will not be included in the design of this invention, and as to those hosts, it will not be necessary for their IP addresses to be preconfigured in the VPN-router: if desired, they may use DHCP. Each actual host on a LAN must have its actual address cross referenced with that host's virtual address on the remote LAN (the LAN at the other end of the tunnel), and each virtual address on the LAN must be cross referenced to the actual address of the host on the remote LAN. The “home” VPN-router must have a set of internal tables corresponding to each of the remote LANs to which it is connected. For each remote LAN, the “home” VPN-router will maintain a table cross referencing the addresses of actual hosts on the “home” LAN with the virtual addresses of those hosts on the remote LAN, and cross referencing the virtual addresses of remote hosts with the actual addresses used by those hosts on the remote LAN. Where there are two or more “home” LANs, the addressing scheme will simply be applied to each of them. In such a design, each “home” LAN will be treated as a remote LAN by every other “home” LAN.

Once the IP addressing scheme has been created and implemented, each remote host will appear as a virtual host having a unique virtual IP address on the “home” LAN, and each host on the “home” LAN will appear as a virtual host having a unique virtual IP address on each remote LAN. However, hosts on one remote LAN will normally be isolated from other remote LANs, and will not be able to see hosts on other remote LANs unless the network is specifically designed to provide such visibility. In that event, a remote LAN will become a “home” LAN with respect to any other remote LANs it has been configured to “see.”

When an IP packet is to be sent from a host on the “home” LAN to a host on a remote LAN, the packet is first delivered to the “home” VPN-router, using the hardware address for that router. Because the VPN-router “understands” that it may be working with virtual IP addresses, it will respond to ARP requests directed to a virtual host by providing its own hardware address. Upon arriving at the VPN-router, the packet is analyzed and is determined to be either a “normal” packet destined for normal routing and delivery across the internet, or is a “special” packet subject to the method of this invention. If it is a “normal” packet, it will undergo standard processing, including network address translation, and will be forwarded to the internet for delivery. If it is a “special” packet, it's actual source address will be translated to be the unique, private virtual IP address that references the “home” host within the remote LAN's addressing scheme. The packet will then be then encrypted (if desired), and encapsulated within an outer IP packet in which the destination field contains the global IP address of the remote VPN-router, and the source field contains the global IP address of the local VPN-router. The packet will then be then forwarded to the internet, which will route it to the remote NAT gateway. Upon being received by the remote VPN-router, the packet's outer IP header will be stripped, and the destination and source IP addresses are analyzed. The remote VPN-router will find that the destination address is a virtual, and not an actual address of a host on its LAN, and will then translate the virtual destination address to the actual address of that host on its LAN.

A responding packet from the remote host will have as its destination address the virtual address of the “home” host, and will include its own actual address in the source field. When the packet reaches the remote VPN-router, the actual source address will be replaced by the virtual source address of the host as seen by the “home” LAN, and the packet will be encrypted (if desired), encapsulated, and sent along the tunnel to the “home” VPN-router. Upon arrival there, the packet will be decapsulated, and the “home” VPN-router will recognize the destination as being a virtual destination for an actual device on the “home” LAN, and will translate the virtual destination address to the actual address before sending the packet across the “home” LAN.

### BRIEF DESCRIPTION OF THE DRAWINGS

FIG. 1 depicts an internetwork in which a “home” LAN is connected to three remote LANs across the internet.

FIG. 2 depicts the internetwork of FIG. 1 from the perspective of the “home” LAN using the method of this invention.

FIG. 3 shows the internetwork of FIG. 1 from the perspective of one of the remote LANs.

FIG. 4 depicts an example Network Address Scheme for the method of this invention.

FIG. 5 provides an example of VPN-router translation tables for each of the VPN-routers in the network shown in FIG. 1.

FIG. 6 illustrates example address translations for hypothetical transmissions in accordance with this invention.

FIG. 7 illustrates the decision tree used by a VPN-router to route IP packets from a LAN in accordance with the method of this invention.

FIG. 8 illustrates the decision tree used by a VPN-router to route IP packets from the internet in accordance with the method of this invention.

### DETAILED DESCRIPTION OF THE PREFERRED EMBODIMENTS

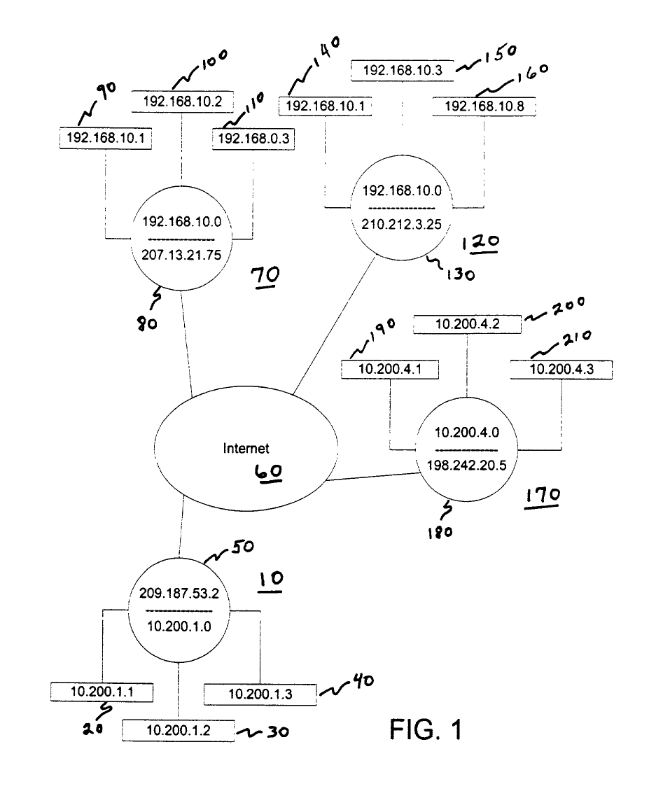

FIG. 1 illustrates a typical network configuration in which a “home” LAN 10 (which will also be referred to as “Network A”) is connected to the internet 60. Remote LANs 70 (“Network B”), 120 (“Network C”) and 170 (“Network D”) are also connected to the internet, but are not connected to each other except across the internet. According to the method of this invention, Networks “A,” “B.,” “C,” and “D” comprise an intranetwork that may be regarded as a virtual LAN on a single network segment, as viewed from the perspective of Network “A.” As viewed from the perspective of any remote network, the LAN will appear to include only that remote network and any “home” network. In FIG. 1, Network “A”'s VPN-router 50 connects hosts 20, 30 and 40 to the internet, but also acts as a firewall to isolate them from the internet and any other network from receiving unwanted communications. Network “A” is the network with which all other networks must be able to communicate as if attached to a LAN, and the local addressing scheme for Network “A” reflects an overall design that is expandable as necessary to incorporate virtually any number of additional networks into the internetwork.

NAT-routers 80, 130, 180 connect Networks “B,” “C,” and “D,” respectively, to the internet in the same manner. Each VPN-router has a global IP address at its interface with the internet, and a local IP address at its interface with its LAN. Network “B” 70 has three hosts, 90, 100 and 110, identified in FIG. 1 by their local IP addresses. Network “B” is a legacy network which has retained the private IP addresses that were assigned prior to the incorporation of Network “B” into the intranetwork. Network “C” has three hosts, 140, 150 and 160, each being identified by its local IP address, and also having legacy local IP addresses. Hosts 140 and 150 on Network “C” have local IP addresses identical to those of hosts 90 and 110 on Network “B.” However, in accordance with the method of this invention, there is no ambiguity when these hosts are included in a virtual LAN, as described below. Network “D” has three hosts, 190, 200 and 210, which also are identified by their local IP addresses. Network “D,” however, uses local IP addresses that were assigned in accordance with an overall intranetwork naming scheme. As a result, it will not be necessary for hosts on Network “D” to have their addresses translated for communications with Network “A.”

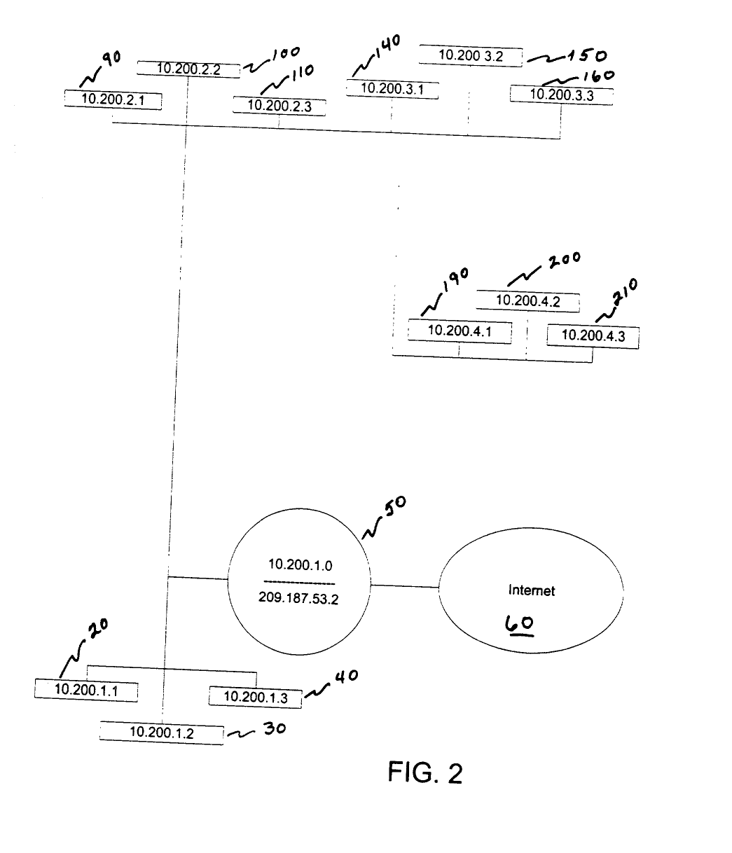

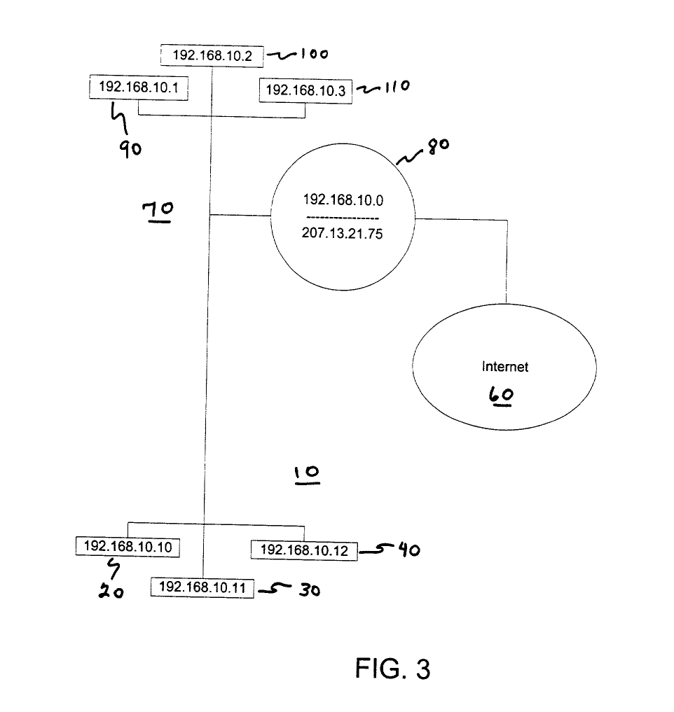

When configured in accordance with the method of this invention, the intranetwork of FIG. 1 will take on the virtual topography illustrated in FIG. 2, as seen from Network “A.” The virtual LAN of FIG. 2 follows the addressing scheme shown in FIG. 3. In accordance with this scheme, hosts on Network “A” may be assigned local IP addresses in the range of 10.200.1.1 up to 10.200.1.255. Because this network is a class A network having a NetID=10, there is no prohibition against assigning an address having a fourth octet of “255” so long as the second and third octets are not also “255,” in which case the address would be reserved for broadcasts across the network. Network “B” will be assigned virtual IP addresses in the range of 10.200.2.1 up to 10.200.2.255. Again, because these addresses are on the class A network having a NetID=10, they will be directly accessible from other hosts on the network. The use of a “2” in the third octet of the addresses is for administrative convenience and ease of reference. Similarly, Network “C” uses virtual IP addresses ranging from 10.200.3.1 up to 10.200.3.255, while Network “D” uses virtual IP addresses from 10.200.4.1 up to 10.200.4.255. As appears in FIG. 2, all hosts on the intranetwork appear as hosts attached to a single segment LAN, making it possible for the to communicate directly with one another using their physical addresses. From the perspective of Network “A,” VPN-router 50 provides a connection to the internet for all communications other than those destined for actual or virtual hosts on the LAN. However, according to the method of this invention, communications between hosts on Network “A” and other actual or virtual hosts on the LAN will take place as if the hosts were all attached to the same network segment.

FIG. 3 depicts the way the internetwork of FIG. 1 would appear from the perspective of Network “B.” Since Network “B” uses local IP addresses that are different from the local IP addresses used by Network “A,” all actual and virtual hosts on the “B” Network will have the local IP addresses assigned for that network.

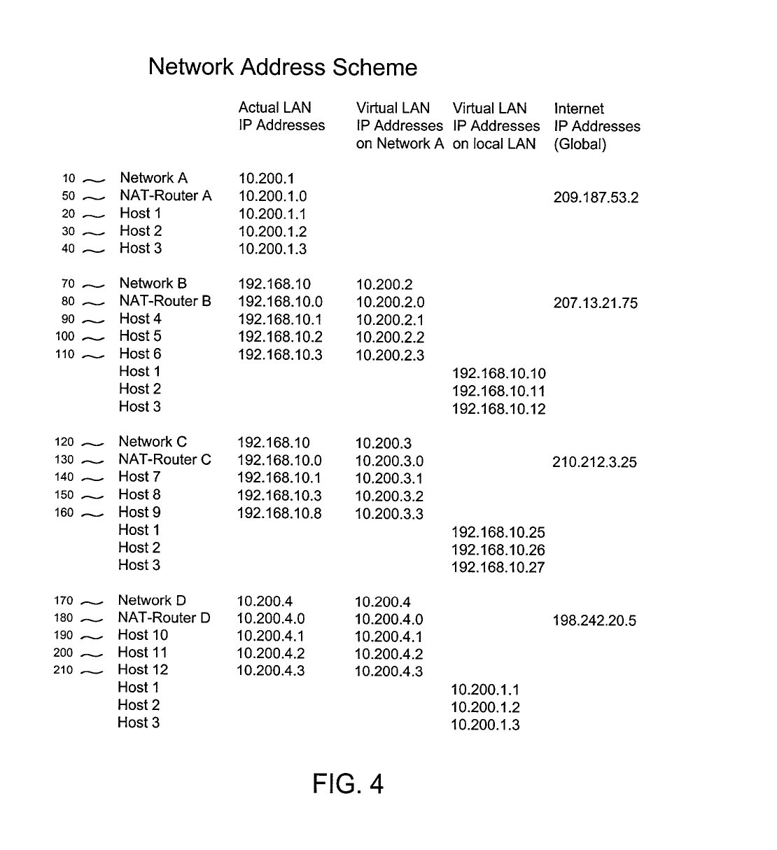

FIG. 4 shows the overall network address scheme. Actual hosts on Network “A” 10 have the actual IP addresses listed for that network. Actual IP addresses for Networks “B” 70, “C” 120, and “D” 170 are listed under “Actual LAN IP Addresses.” Virtual addresses for those networks and the hosts attached to them, as seen from Network “A” are listed under “Virtual LAN IP Addresses on Network A.” Virtual IP addresses of the hosts on Network “A,” as seen locally from the other networks are listed under “Virtual LAN IP Addresses on Local LAN.” The global IP addresses of the VPN-routers are listed under “Internet IP Addresses (Global).” Each host on each network has been designated by a number (Host 1, Host 2, etc. . . . ) for ease of reference. The host numbers, however, are simply illustrative references, and have nothing to do with the addressing scheme of this invention.

As shown in FIG. 4, each host on Networks “B.”, “C,” and “D” has been assigned a virtual IP address by which it can be referenced from Network “A.” FIG. 4 also shows that the virtual addresses assigned to Network “D” are the same as the actual local IP addresses for that network. As a general rule, where remote networks are to be incorporated into the internetwork design of this invention, local IP addresses should be assigned to correspond with the virtual IP addresses for that network unless other considerations (such as a desire to maintain an earlier addressing scheme, or the need to maintain compatibility with other parts of a pre-existing LAN) outweigh that choice.

Because hosts on Networks “B.”, “C,” and “D” must be able to send packets to hosts on Network “A,” virtual IP addresses must be assigned to those hosts from the available address space for each of those networks. In accordance with this requirement, virtual IP addresses have been assigned to hosts 1, 2 and 3 from unused addresses on Network “B”: Host 1 has the virtual IP address “192.168.10.10”; host 2 has the virtual IP address “192.168.10.11”; and the virtual IP address “192.168.10.12” is assigned to host 3. A similar scheme is used to assign virtual IP addresses to hosts 1, 2 and 3, as seen from Network “C.” However, because Network “D” was designed from the ground up to fit within the addressing scheme for the intranet of this invention, the actual addresses for hosts 1, 2 and 3 on Network “A” can also serve as the virtual addresses for those hosts, as seen from Network “D.”

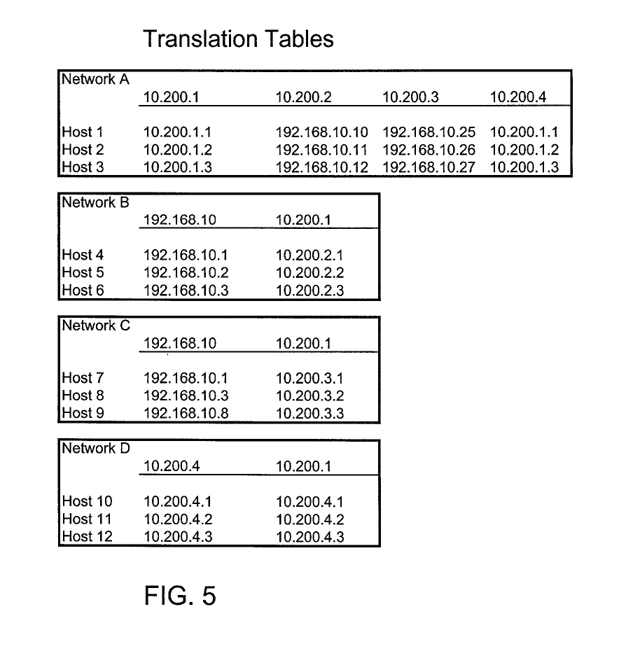

Internal translation tables for the VPN-routers shown in FIG. 1 are given in FIG. 5. Because Network “A” must be able to communicate directly with Networks “B.” “C,” and “D,” it must have a translation table for packets destined to each of those networks. The purpose for translation by VPN-router “A” is to replace the source address in the packet's IP header with the virtual address of the host on Network “A” from which the packet originated. In this manner, a reply packet from the remote network will be able to use the source address from the packet it received as the destination address for the reply packet it will send. The packet will then be encapsulated and sent VPN-router to VPN-router via the internet, where it will be routed according to standard routing protocols. Upon arrival at the receiving VPN-router, the packet will be decapsulated, and the “inner” IP packet will have its destination address translated in accordance with the receiving VPN-router's translation table. As shown in FIG. 5, the VPN-routers for Networks “B,” “C,” and “D” have only one set of translation tables each, which will be sufficient for the internetwork shown in FIG. 1. However, if it is desired that any of those networks should be able to communicate directly with any other one of them, a second set of translation tables would have to be added to the VPN-router for each to perform the necessary address translation. In this event, additional unused local IP addresses would have to be available for assignation to the virtual hosts to be added to each network.

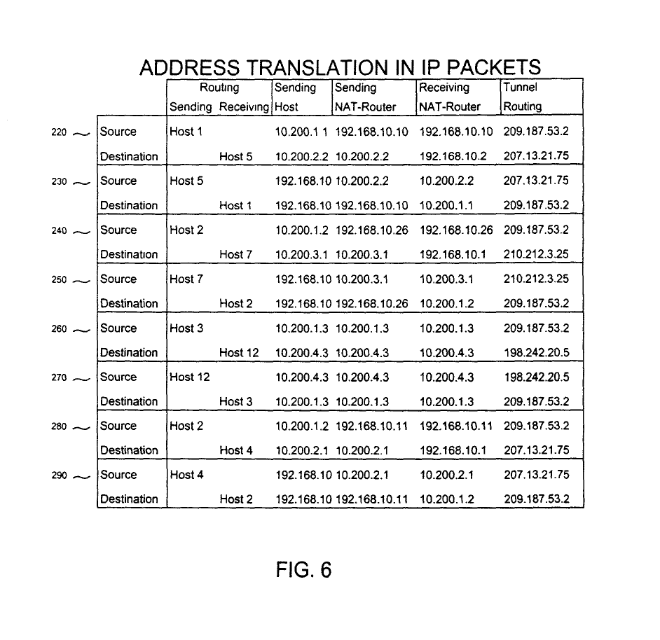

FIG. 6 provides eight examples of the method of address translation of this invention. At 220, a packet is sent from Host 1 on Network “A” to Host 5 on Network “B.” As the packet leaves Host 1, its source field contains the actual IP address of Host 1, and its destination field contains the virtual IP address of Host 5, as seen from Network “A.” When the packet reaches the sending VPN-router, which in this case is VPN-router “A,” its source address is translated to Host 1's virtual IP address, as seen from Network “B” (“192.168.10.10”). VPN-router “A” may encrypt the packet, or provide authentication information for security, and will then encapsulate the packet for transit along the tunnel to VPN-router “B.” The encapsulation header will also be an IP header, and the source and destination addresses will be the global IP addresses of the two VPN-routers that are the endpoints of the tunnel, as shown in the column headed “Tunnel Routing.” At the receiving VPN-router (VPN-router “B”), the packet is decapsulated and, if necessary, decrypted and authenticated. VPN-router “B” will then translate the destination address to be the actual IP address of Host 5, in accordance with its translations tables, and will send the packet to Network “B.” (As previously described, VPN-router “B” will actually send the packet to the physical address of Host 5 although, for purposes of this invention, this step will be transparent). The packet will be received by Host 5, and will bear the actual IP address of that host in its destination field and the virtual IP address of Host 1 in its source field.

At 230, Host 5 sends a responsive packet back to Host 1. The same procedure is followed in which the packet will have the actual IP address of Host 5 in its source field, and the virtual IP address of Host 1, as seen from Network “B,” in its destination field. At VPN-router “B,” the source field of the packet is translated to be the virtual address of Host 5, as seen from Network “A,” and the packet is processed for security, encapsulated, and routed to VPN-router “A.” At VPN-router “A” the packet is decapsulated, processed for security, and the destination IP address is translated to be Host 1's actual IP address. Similar address translation occurs for transmissions 240 through 290. It may be noted that transmissions at 240-250 involve Host 7 on Network “C” while transmissions at 280-290 involve Host 4 on Network “B.” Although these hosts have identical actual IP addresses on their respective networks, there is no conflict or ambiguity in the sending or receipt of transmissions to these hosts because each has a unique virtual IP address as seen from Network “A.”

The VPN-router of this invention must be specially configured to hold virtual IP addresses in its translation tables, and to identify IP packets being transmitted to or from the virtual hosts having virtual IP addresses. This behavior is different from the standard behavior of a NAT or a router, and must be specifically designed into the VPN-router of this invention. All VPN-routers used to isolate the networks comprising the internetwork of this invention may be the same in their hardware and firmware, and would differ only in the mapping of actual and virtual IP addresses in accordance with the addressing scheme of this invention.

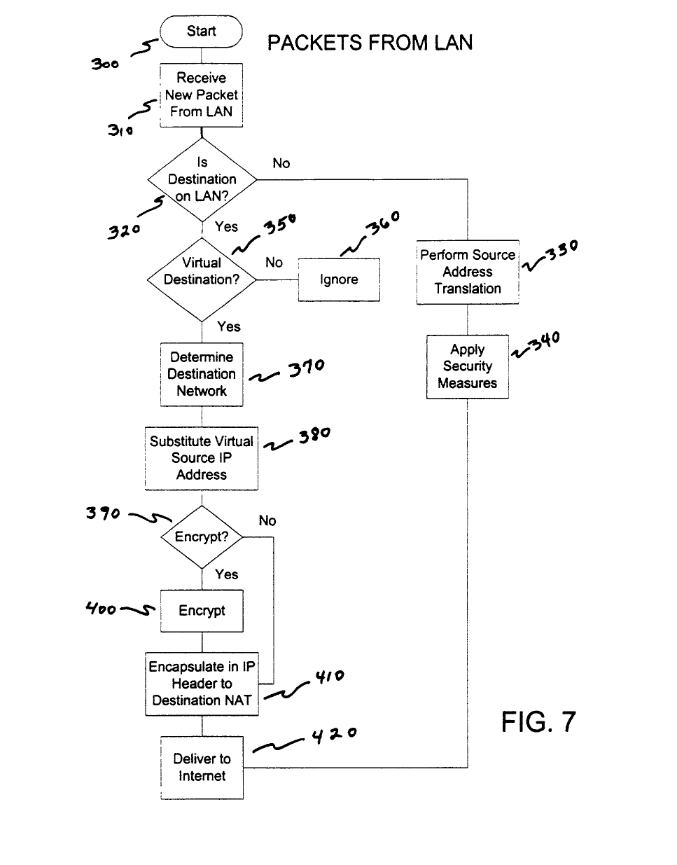

FIG. 7 depicts a decision tree that a VPN-router would use to route IP packets from its local network. The process begins at 300, and at 310 a packet is received from the local network. The packet is first examined 320 to see whether it is destined for an IP address appearing on the local network, or should be sent to the internet. If it is destined for delivery to the internet, “normal” source address translation 330 and security measures 340 will be applied and the packet will be delivered to the internet for further routing. However, if the packet is destined for the local network, the NAT router will then consult its internal tables to determine whether the destination IP address is actual or virtual 350. If the packet is being sent to an actual IP address on the local network, the receiving host will be actually attached to the network, and will receive the packet without any action being taken by the VPN-router, which may ignore the packet 360. If the destination address is a virtual address, the VPN-router must determine to which local network in the intranetwork the packet should be routed 370. In the example intranetwork illustrated in FIG. 1, if the VPN-router is attached to Networks “B,” “C,” or “D,” then the only virtual network to which the packet could be routed is Network “A.” If, however, the packet is received by VPN-router “A” from Network “A,” then it will be necessary for the router to determine whether the virtual IP address is on Network “B,” “C,” or “D.” A similar determination will also need to be made for intranetworks in which more than one network is configured as a “home” network.

Once the network to which the packet will be forwarded has been identified, the VPN-router will substitute the virtual IP address of the sending host 380. If encryption 390 (or other security measures) have been activated, the VPN-router will perform the encryption 400 or other security measures. The VPN-router will next encapsulate the packet within an IP packet addressed to the VPN-router for the destination network 410, and will deliver the encapsulated packet to the internet 420 for routing to the destination VPN-router.

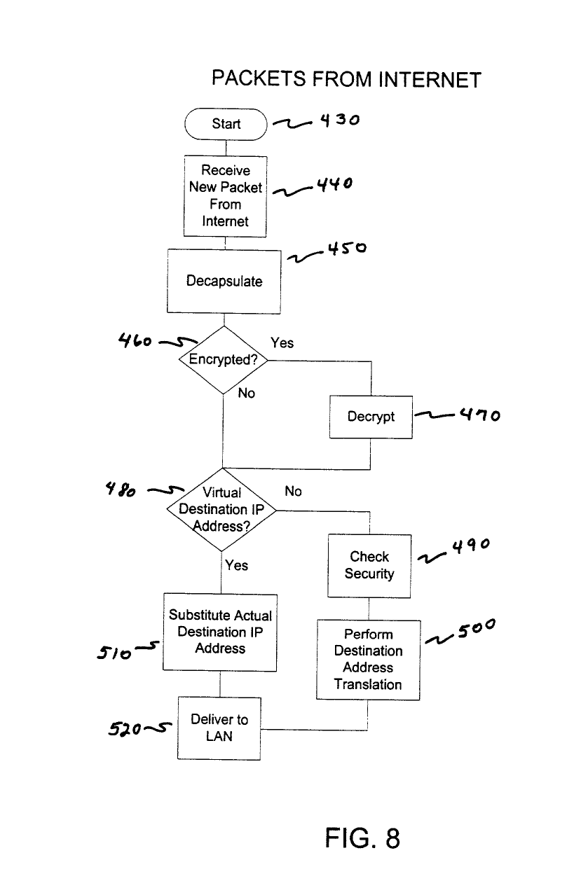

FIG. 8 illustrates the decision tree for IP packets received from the internet by a VPN-router. The process begins at 430, and at 440 a new packet is received from the internet. The packet must be decapsulated 450 and inspected. If it is encrypted 460, it must first be decrypted 470 before further analysis can take place. If the IP packet, now free of encapsulation, has an actual destination IP address, then the packet will be processed “normally,” that is, it will be authenticated 490 and destination address translation 500 will be performed. Here, it may be noted that, in some implementations the actual destination IP address for a “normal” packet may be the VPN-router's global IP address, which will then be translated in accordance with other criteria maintained by the VPN-router. However, where the decapsulated packet has a virtual IP address in its destination field, the VPN-router will translate that to be the receiving host's actual local IP address, and will deliver the packet to the local network for delivery to the host.

While the invention has been described, disclosed, illustrated and shown in various terms or certain exemplary embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim:

1. On a plurality of IP networks, each of said plurality of networks being remote from every other network, each said network being connected to the internet by a VPN-router, a method of sending an IP packet from a host on one of said plurality of networks to a host on another of said plurality of networks, comprising the steps of:
a. assigning a netID to each network of said plurality of networks;
b. assigning an IP address to each host on each said network, said IP address for each said host having the same netID as the network to which said host is attached, each said host having a hostID that is unique to said host's network;
c. for each said network, assigning a virtual IP address to said network representing a host on a remote network, said virtual IP address having the same netID as said network and a hostID that is unique to said network;
d. creating in each said VPN-router connected to each said network, one or more tables cross referencing each virtual IP address on said network to the netID of the remote network of the host which said virtual IP address represents, and cross referencing each host attached to said network to each virtual remote IP address representing said host on each remote network;
e. sending an IP packet from a host on one of said plurality of networks to a host on another of said plurality of networks, said IP packet.

2. A method of sending an IP packet as claimed in claim 1 wherein one of said networks is a home network and the remaining networks in said plurality of networks are remote networks, said IP addresses and said virtual IP addresses assigned to said home network being taken from a range of reserved private IP addresses, said range being one of three blocks of IP addresses, a first block comprising contiguous IP addresses from 10.0.0.0 and extending through 10.255.255.255, a second block comprising contiguous IP addresses from 172.16.0.0 and extending through 172.16.255.255, and a third block comprising contiguous the IP addresses from 192.168.0.0 and extending through 192.168.255.255.

3. A method of sending an IP packet as claimed in claim 2 wherein IP addresses and virtual IP addresses assigned to said remote networks are taken from the same said range of reserved private IP addresses as said IP addresses and virtual IP addresses assigned to said home network.

4. A method of sending an IP packet as claimed in claim 1 wherein said IP packet is sent from a first host attached to a first network in said plurality of networks, said first host having an IP address on said first network, to a second host attached to a second network in said plurality of networks, said second host having an IP address on said second network, said first and second networks being attached to the internet and being remote from each other, comprising the further steps of:
a. said first host sending an IP packet to a first VPN-router connecting said first network to the internet, said IP packet having a header that includes a destination IP address and a source IP address, said destination IP address being a virtual IP address assigned to said first network representing said second host, and said source IP address being said IP address of said first host on said first network;
b. said first VPN-router receiving said IP packet, determining the virtual remote IP address representing said first host upon said second network, replacing said source IP address with said virtual remote IP address representing said first host upon said second network, encapsulating said IP packet as a payload within an encapsulating IP packet, providing said encapsulating IP packet with a destination IP address of a second remote VPN-router connecting said second network to the internet, and sending said encapsulating IP packet to the internet for routing and delivery to said second VPN-router;
c. said second VPN-router receiving said encapsulating IP packet, decapsulating said encapsulating IP packet to recover said IP packet, determining the IP address of said second host on said second network, replacing said destination IP address of said IP packet with said IP address of said second host on said second network, and sending said IP packet to said second network for delivery to said second host.

5. A method of sending an IP packet as claimed in claim 4, further comprising the steps of:
a. said first host encrypting the payload of said IP packet prior to sending said IP packet to said first VPN-router; and
b. said second host decrypting said payload of said IP packet upon receiving said IP packet from said second VPN-router.

6. A method of sending an IP packet from a first host attached to a first network to a second host attached to a second network, and sending a second IP packet from said second host to said first host, said first and second networks being attached to the internet, comprising the steps of:
a. assigning a first IP address to said first host attached to said first network, said first IP address comprising a netID and a hostID that is unique to said first network;
b. assigning a second and third IP address to a first VPN-router connecting said first network to the internet, said second IP address being assigned to said VPNrouter's interface to said first network and having the netID of said first network and a hostID that is unique to said first network, said third IP address being assigned to said first VPN-router's interface with the internet and being a globally unique IP address;
c. assigning a fourth IP address as a virtual IP address to represent, on said first network, said second host, said second host being attached to said second network that is attached to the internet and that is remote from said first network, said fourth IP address having the netID of said first network and a hostID that is unique to said first network;
d. assigning a fifth IP address to said second host attached to said second network, said fifth IP address having the netID of said second network and a hostID that is unique to said second network;
e. assigning a sixth and seventh IP address to a second VPN-router connecting said second network to the internet, said sixth IP address being assigned to said VPN-router's interface to said second network and having the netID of said second network and a hostID that is unique to said second network, said seventh IP address being assigned to said second VPN-router's interface with the internet and being a globally unique IP address;
f. assigning an eighth IP address as a virtual IP address to represent, on said second network, said first host, said eighth IP address having the netID of said second network and a hostID that is unique to said second network;
g. creating a table in said first VPN-router whereby said fourth IP address is cross referenced to said seventh IP address, and said first IP address is cross referenced to said eighth IP address;
h. creating a table in said second VPN-router whereby said eighth IP address is cross referenced to said third IP address, and said fourth IP address is cross referenced to said fifth IP address;
i. sending said first IP packet from said first host, said first IP packet having as its destination IP address said fourth IP address and having as its source address said first IP address;
j. receiving said first IP packet at said first network interface of said first VPN-router, replacing said source IP address in said first IP packet with said eighth IP address, encapsulating said first IP packet as a payload within a first encapsulating IP packet having as its destination IP address said seventh IP address, and sending said first encapsulating IP packet to the internet for routing to said second VPN-router;
k. receiving said first encapsulating IP packet at said second VPN-router, decapsulating said payload to obtain said first IP packet, examining said first IP packet to determine said first IP packet's destination, replacing said first IP packet's destination IP address with said fifth IP address, and placing said first IP packet on said second network for delivery to said second host;
l. receiving said first IP packet at said second host, and sending a second IP packet from said second host to said first host.

7. The method of sending a first IP packet from a first host to a second host and sending a second IP packet from said second host to said first host as claimed in claim 6, comprising the further steps of:
l. sending said second IP packet from said second host, said second IP packet having as its destination IP address said eighth IP address and having as its source address said fifth IP address;
m. receiving said second IP packet at said second VPN-router's interface to said second network, replacing said source address with said fourth IP address, encapsulating said second IP packet as a payload within a second encapsulating IP packet having as its destination IP address said third IP address, and sending said second encapsulating packet to the internet for routing to said first VPN-router; and
n. receiving said second encapsulating IP packet at said first VPN-router, decapsulating said payload to obtain said second IP packet, examining said second IP packet to determine said second IP packet's destination, replacing said second IP packet's destination IP address with said first IP address, and placing said second IP packet on said second network for delivery to said first host attached to said first network.

8. A method of sending a plurality of IP packets from one or more hosts attached to a first network to one or more remote hosts attached to one or more networks remote from said first network, said first network and each of said one or more remote networks being connected to the internet by a VPN-router, comprising the steps of:
a. assigning a netID to said first network and to each network of said one or more remote networks;
b. assigning an IP address to each host of said one or more hosts attached to said first network and to each remote host attached to each of said one or more remote networks, each said host's IP address having the same netID as the network to which said host is attached, and each said host's IP address having a hostID that is unique to said host's network;
c. assigning one or more virtual IP addresses to said first network, each said virtual IP address representing one of said one or more remote hosts on said one or more remote networks, each said virtual IP address having the same netID as said first network and a hostID that is unique to said first network;
d. assigning one or more virtual IP addresses to each of said one or more remote networks, each of said one or more virtual IP addresses representing a host on said first network
e. creating in said VPN-router connected to said first network, one or more tables cross referencing each virtual IP address on said first network to the netID of the remote network of the host which said virtual IP address represents, and cross referencing each host attached to said first network to each virtual IP address representing each said host on each of said one or more remote networks;
f. creating in each VPN-router connecting one of said one or more remote networks to the internet one or more tables cross referencing each virtual IP address on said remote network to said first network, and cross referencing the IP address of each remote host on said remote network to the virtual IP address representing said remote host on said first network;
g. sending a plurality of IP packets from one or more said hosts on said first network to one or more said remote hosts on one or more said remote networks, the destination IP address of each IP packet in said plurality of IP packets being the said virtual IP address on said first network of the said remote host to which the said IP packet is sent, and the source IP address of each said IP packet in said plurality of IP packets being the said local IP address of the said host on said first network from which the said IP packet is sent;
f. receiving said plurality of IP packets at said first VPN router and, for each said packet, determining the said source IP address of the said host on said first network sending said IP packet and replacing said source IP address with the said virtual IP address representing said sending host on the said remote network to which said IP packet is being sent, determining the remote network of the remote host to which said IP packet is addressed, encapsulating said IP packet as a payload within an encapsulating IP packet, addressing said encapsulating IP packet for delivery to the said remote VPN-router attached to said remote network, and placing said encapsulating IP packet on the internet, such that a plurality of encapsulating IP packets are routed from said first VPN-router to said one or more remote VPN-routers;
g. for each of said one or more remote VPN-routers attached to one of said one or more remote networks, receiving one or more of said plurality of encapsulating IP packets at said remote VPN-router and, for each of said one or more encapsulating IP packets, decapsulating said encapsulating IP packet to obtain said IP packet, examining said IP packet to determine the said virtual destination IP address, replacing said virtual destination IP address with the IP address of the remote host to which said IP packet is directed on said remote network, and sending said IP packet to said remote network for delivery to said remote host.

9. The method of sending a plurality of IP packets from one or more local hosts attached to a first network to one or more remote hosts attached to one or more remote networks as claimed in claim 8, comprising the further steps of encrypting said one or more IP packets at said first VPN-router prior to encapsulation and transmission to said one or more remote VPN-routers; and decrypting said one or more IP packets at said one or more remote VPN-routers after decapsulation and before transmission to said one or more remote networks.
